(19) United States
(12) Patent Application Publication
(10) Pub. No.: US 2015/0086961 A1
(43) Pub. Date: Mar. 26, 2015

(54) E-learning system and method therefor

(71) Applicants: Chien Cheng Liu, Kaohsiung (TW); Kuan Chen Wang, Kaohsiung (TW)

(72) Inventors: Chien Cheng Liu, Kaohsiung (TW); Kuan Chen Wang, Kaohsiung (TW)

(21) Appl. No.: 14/034,574

(22) Filed: Sep. 24, 2013

(51) Int. Cl. G09B 5/08

(52) U.S. Cl. CPC G09B 5/08
USPC 434/350

(57) ABSTRACT

An e-learning method is provided with allowing a teacher to use remote data processing device to communicate with users over the Internet; allowing the teacher and the users to access an online teaching database over the Internet by using the remote data processing device respectively wherein the online teaching database includes a curriculum server, an examination server, a user records server, and an academic server; allowing the teacher to access the curriculum server by using the remote data processing device; allowing the teacher to access a curriculum or a video from the curriculum server for teaching; allowing the users to access the curriculum server by using the remote data processing device; allowing the users to download the curriculum or the video; allowing the teacher to communicate with the users; and allowing the teacher to designate a user to access the examination server by using the remote data processing device.

### BACKGROUND OF THE INVENTION

1. Field of the Invention

The invention relates to online education and more particularly to an e-learning system and method therefor.

2. Description of Related Art

There is a conventional e-learning system configured to provide a learning management system for presenting an exercise environment to a user. The user can practice skills through a combination of presented media and practice areas. The e-learning system provides feedback to the user during the practice session to allow the user to improve performance while in the exercise environment. Further, the e-learning system tracks the user's performance in terms of practice time and in terms of accuracy percentage to allow the student and the educator to monitor performance related to effort.

Notwithstanding the literature, the invention is neither taught nor rendered obvious thereby.

### SUMMARY OF THE INVENTION

It is therefore one object of the invention to provide an e-learning method comprising the steps of allowing a teacher to use one of a plurality of remote data processing devices to communicate with a plurality of users over the Internet; allowing the teacher and the users to access an online teaching database over the Internet by using one of the remote data processing devices respectively wherein the online teaching database includes a curriculum server, an examination server, a user records server, and an academic server interconnected; allowing the teacher to access the curriculum server by using one of the remote data processing devices; allowing the teacher to access a curriculum or a video from the curriculum server for teaching; allowing one of the users to access the curriculum server by using one of the remote data processing devices; allowing one of the users to download the curriculum or the video; allowing the teacher to communicate with the users; allowing the teacher to designate one of the users to access the examination server by using one of the remote data processing devices; storing a plurality of test scores as files in the user records server; allowing the teacher to access the user records server by using one of the remote data processing devices so as to access the files; allowing the teacher to access the online social networking service database by using one of the remote data processing devices; and allowing the teacher to publish the test scores on a web page for the users access and review.

The above and other objects, features and advantages of the invention will become apparent from the following detailed description taken with the accompanying drawings.

### BRIEF DESCRIPTION OF THE DRAWINGS

FIG. 1 schematically depicts an e-learning system according to the invention.

### DETAILED DESCRIPTION OF THE INVENTION

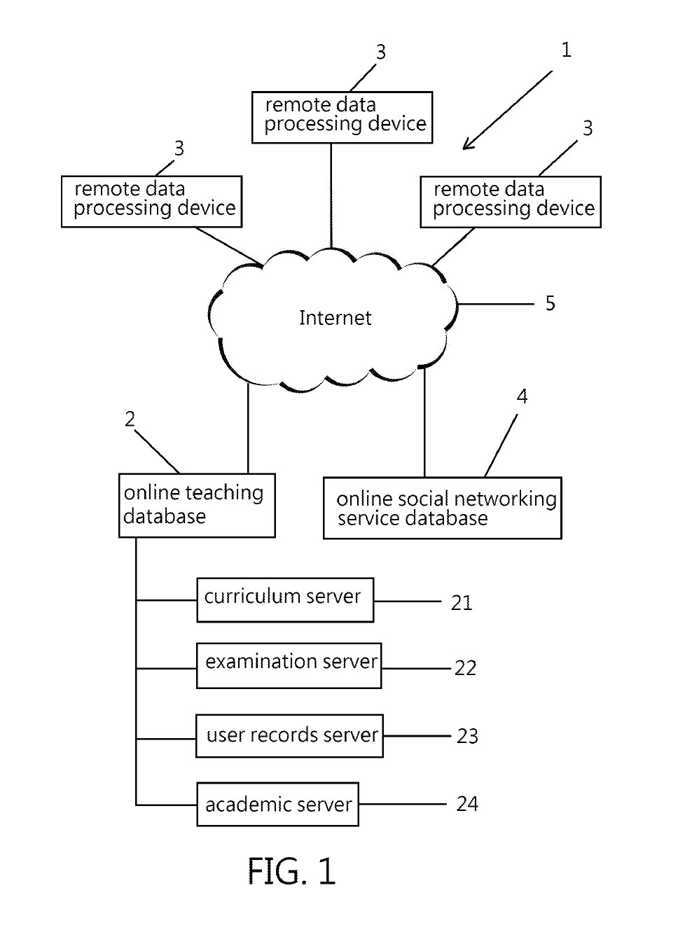

Referring to FIG. 1, an e-learning system 1 in accordance with the invention comprises the following components as discussed in detail below.

An online teaching database 2, an online social networking service database 4, and a plurality of remote data processing devices 3 are provided. The online teaching database 2 and the online social networking service database 4 are connected to the

Internet 5 by wire or wireless respectively. The remote data processing devices 3 are connected to the Internet 5 by wire, wireless, or 3G (or 3.5G or 4G) respectively. As a result, information can be communicated among the online teaching database 2, the online social networking service database 4, and the remote data processing devices 3 over the Internet 5.

The online teaching database 2 includes a curriculum server 21, an examination server 22, a user records server 23, and an academic server 24 interconnected by the Internet 5. The online social networking service database 4 is one of online social networking services including Facebook, Twitter, Google, Tumblr, and LinkedIn. The remote data processing device 3 is a Smartphone, tablet computer, laptop computer, or desktop computer.

Teaching videos, curriculums, etc. are stored in the curriculum server 21. Audio and video (AV) examination bank, on-line examination bank, curriculum examination papers, previous examination papers, etc. are stored in the examination server 22. User records, duty records, AV files, examination bank records, examination paper files, etc. are stored in the user records server 23.

An e-learning method can be online learning method, distant learning method, or classroom teaching method by implementing on the e-learning system 1.

The online teaching method comprises allowing a teacher to use the remote data processing device 3 to communicate with a plurality of students (i.e., users) over the Internet 5 in an interactive manner. The teacher can teach and discuss questions with the students. The teacher and the students can access the online teaching database 2 over the Internet 5 by using the remote data processing devices 3 respectively.

The teacher can access the curriculum server 21 by using the remote data processing device 3. The teacher then accesses a desired curriculum or video for teaching. The student may access the curriculum server 21 by using the remote data processing device 3. Then the student may download the specific curriculum to read or the specific video for viewing. The teacher may teach the students and discuss the teaching materials at the same time.

The teacher may designate a student to access the examination server 22 by using the remote data processing device 3. Thus, the student may take an examination by answering questions on the examination paper. This is a self learning process. All communications done in the self learning process are recorded as AV files and stored in the user records server 23.

The teacher can access the user records server 23 by using the remote data processing device 3 so as to access the AV files and discuss with the student. The teacher may use the remote data processing device 3 to access the online social networking service database 4. Then the teacher may use a personal webpage to publish scores of the examination been taken. Other information including comments, opinions, the AV files, etc. can also be published for students access and review.

The distant learning method comprises allowing any student to access the curriculum server 21 at any time by using the remote data processing device 3. Then the student may download the specific curriculum to read or the specific video for viewing.

The distant learning method further comprises allowing any student to access the examination server 22 at any time by using the remote data processing device 3. Thus, the student may take an examination by answering questions on the examination paper. This is a self learning process. All communications done in the self learning process are recorded as AV files and stored in the user records server 23.

The distant learning method further comprises allowing the teacher to access the user records server 23 by using the remote data processing device 3 so as to access the AV files and discuss with the student. The teacher may use the remote data processing device 3 to access the online social networking service database 4. Then the teacher may use a personal webpage to publish scores of the examination been taken. Other information including comments, opinions, the AV files, etc. can also be published for students access and review.

The classroom teaching method comprises allowing any student to access the curriculum server 21 in the classroom by using the remote data processing device 3. Then the student may download the specific curriculum to read or the specific video for viewing.

The classroom teaching method further comprises allowing any student to access the examination server 22 in the classroom by using the remote data processing device 3. Thus, the student may take an examination by answering questions on the examination paper. This is a self learning process. All communications done in the self learning process are recorded as AV files and stored in the user records server 23.

The classroom teaching method further comprises allowing the teacher to access the user records server 23 in the classroom by using the remote data processing device 3 so as to access the AV files and discuss with the student. The teacher may use the remote data processing device 3 to access the online social networking service database 4. Then the teacher may use a personal webpage to publish scores of the examination been taken. Other information including comments, opinions, the AV files, etc. can also be published for students access and review.

While the invention has been described in terms of preferred embodiments, those skilled in the art will recognize that the invention can be practiced with modifications within the spirit and scope of the appended claims.

What is claimed is:

1. An e-learning method comprising the steps of:
allowing a teacher to use one of a plurality of remote data processing devices to communicate with a plurality of users over the Internet;
allowing the teacher and the users to access an online teaching database over the Internet by using one of the remote data processing devices respectively wherein the online teaching database includes a curriculum server, an examination server, a user records server, and an academic server interconnected;
allowing the teacher to access the curriculum server by using one of the remote data processing devices;
allowing the teacher to access a curriculum or a video from the curriculum server for teaching;
allowing one of the users to access the curriculum server by using one of the remote data processing devices;
allowing one of the users to download the curriculum or the video;
allowing the teacher to communicate with the users;
allowing the teacher to designate one of the users to access the examination server by using one of the remote data processing devices;
storing a plurality of test scores as files in the user records server;
allowing the teacher to access the user records server by using one of the remote data processing devices so as to access the files;
allowing the teacher to access the online social networking service database by using one of the remote data processing devices; and
allowing the teacher to publish the test scores on a web page for the users access and review.

2. The e-learning method of claim 1, wherein the e-learning method is an online learning method, a distant learning method, or a classroom teaching method.
